(19) United States
(12) Patent Application Publication
(10) Pub. No.: US 2005/0242731 A1
(43) Pub. Date: Nov. 3, 2005

(54) Plasma display panel

(76) Inventors: Seung-Uk Kwon, Suwon-si (KR); Kyoung-Doo Kang, Suwon-si (KR)

Correspondence Address: MCGUIREWOODS, LLP, 1750 TYSONS BLVD, SUITE 1800, MCLEAN, VA, 22102, US

(21) Appl. No.: 11/118,378

(22) Filed: May 2, 2005

(30) Foreign Application Priority Data
May 3, 2004 (KR) 10-2004-0030936

(51) Int. Cl. H01J 17/49

(52) U.S. Cl. 313/586

(57) ABSTRACT

A plasma display panel decreases reflected luminance of external light and increase discharge efficiency. The plasma display panel may comprise, among other things, a second colored dielectric layer that covers the pair of the sustain electrodes, a fluorescent layer arranged inside each discharge cell; and discharge gas present in the discharge cells, wherein grooves are formed on the second dielectric layer and between the sustain electrode pairs.

### BACKGROUND OF THE INVENTION

This application claims the priority of Korean Patent Application No. 10-2004-0030936, filed on May 3, 2004, in the Korean Intellectual Property Office, the disclosure of which is herein incorporated by reference in its entirety.

### FIELD OF THE INVENTION

The invention relates to a plasma display panel, and more particularly, to a plasma display panel that decreases reflected luminance of external light and improves discharge efficiency.

### DESCRIPTION OF THE RELATED ART

In recent years, the plasma display panel has been heralded as a replacement for the conventional cathode-ray tube display. The plasma display panel is a device in which discharge gas is sealed between two substrates, each having a plurality of electrodes. When a discharge voltage is applied, the electrodes scatter electrons into the gas, which energizes to produce ultraviolet rays. Within the device, fluorescent layers are formed in a predetermined pattern. When impinged by the ultraviolet rays, the fluorescent layers emit colored light, which is used to produce a desired image for viewing.

FIGS. 1 and 2 show a conventional AC type three-electrode surface-discharge plasma display panel 10. FIG. 1 is an exploded cut-away perspective view illustrating a general plasma display panel 10. FIG. 2 is a longitudinal cross-sectional view illustrating an internal structure of the plasma display panel illustrated to FIG. 1, where a lower plate thereof is rotated approximately 90°. The plasma display panel 10 comprises an upper plate 50 and a lower plate 60 coupled to be parallel to the upper plate 50. Pairs of sustain electrodes 12 with pairs of X electrodes 31 and Y electrodes 32 are arranged in a front substrate 11 of the upper plate 50. Address electrodes 22 positioned substantially orthogonal to the electrodes 31, 32 are arranged on a back substrate 21 of the lower plate 60 opposite to surfaces in which pairs of the sustain electrodes 12 are arranged. The X electrodes 31 and the Y electrodes 32 are provided with transparent electrodes 31a, 32a and bus electrodes 31b, 32b, respectively. Space formed by a pair of the X electrodes 31 and the Y electrodes 32 and a pair of orthogonal address electrodes 22 forms a unit discharge cell. The first dielectric layer 25 is formed to bury each of the address electrodes 22 on the back substrate 21. The second dielectric layer 15 is formed to bury each of the sustain electrodes 12 on the front substrate 11.

Protective layer 16, ordinarily made of MgO, is formed on the back surface of the second dielectric layer 15, and partition walls 30 for keeping a discharge distance and preventing electrical and optical cross-talk between the discharge cells are formed on the front surface of the first dielectric layer 25. Fluorescent layers 26 of red, green, and blue are coated on both side surfaces of the partition walls 30 and the front surface of the first dielectric layer 25 over which the partition walls 30 are not formed.

In use, a two-pronged method is used to drive the electrodes that form part of the conventional PDP 10. A driver is provided for address discharge, and a driver is provided for sustain discharge. The address discharge occurs owing to potential difference between the address electrodes 22 and the Y electrodes 32, and facilitates the formation of wall charges. The sustain discharge takes place owing to potential difference between the X electrodes 31 and the Y electrodes 32 situated at a discharge space in which the wall charges are generated. This sustain discharge becomes the main discharge used to display an actual visual image.

In a conventional technique, reflected luminance of external light may be reduced by manufacturing the front substrate 11 with colored glass or with glass having black stripes (not shown) to increase contrast of the plasma display panel 10 when viewed in ambient external light. Although this technique may decrease the reflection of external light, it also decreases the display's brightness and luminous efficiency because the colored or striped glass absorbs some of the visible rays generated in the PDP.

FIG. 2 shows an illustrative distribution of wall charges and their respective discharge paths at one portion of a sustain discharge unit in the conventional plasma display panel 10. In use, the sustain discharge begins between the X electrodes 31 and the Y electrodes 32. However, because of the characteristics of plasma, the discharge first spreads to the central portions of the electrodes 31, 32, and then to the outside of the electrodes 31, 32, where it fades and disappears. At this time, the wall charges are locally converged instead of being evenly distributed over an entire area of the electrodes 31, 32. Further, discharge f1 may occur at the inside of the electrodes 31, 32 and discharge f2 may occur in central portions of the electrodes 31, 32, but discharge f3 may be difficult to occur at the outside of the electrodes 31, 32 due to a shortage of wall charges. This may increase the discharge voltage and decrease luminous efficiency because it is difficult to initiate an even discharge over all areas of the sustain electrodes.

There is a need to provide a plasma display panel having decreased discharge voltage and increased luminous efficiency.

### SUMMARY OF THE INVENTION

The present invention provides a plasma display panel that decreases reflection brightness of external light and improves discharge efficiency.

The present invention provides a plasma display panel comprising, among other things, a colored second dielectric layer that covers the pair of the sustain electrodes.

Another aspect of the present invention provides a plasma display panel comprising, among other things, a second dielectric layer that individually covers the sustain electrodes.

The second dielectric layer may have a light transmittance rate of about 50% to about 80% of visible rays. The second dielectric layer may be made of materials including transparent dielectric substances and dark color pigments.

In a plasma display panel manufactured according to the principles of the present invention, the colored second dielectric layer decreases reflection of external ambient light. This has the effect of improving contrast and presenting a clearer picture for the viewer. Additionally, screen brightness is maximized because the grooves formed in the second dielectric layer reduce the layer's absorption of visible rays generated from the discharge cells. Furthermore, because the grooves are formed between pairs of sustain electrodes, a discharge area and discharge path are generally increased. Therefore, a firing discharge voltage and a sustain discharge voltage can be lowered. Additionally, lower ratings of various electronic elements required to drive the plasma display panel reduce the purchase cost of such electronic elements, which translates into lower manufacturing costs and lower prices for consumers.

### BRIEF DESCRIPTION OF THE DRAWINGS

The above and other features and advantages of the present invention will become more apparent by describing in detail exemplary embodiments thereof with reference to the attached drawings.

FIG. 1 is an exploded cut away perspective view illustrating a conventional plasma display panel.

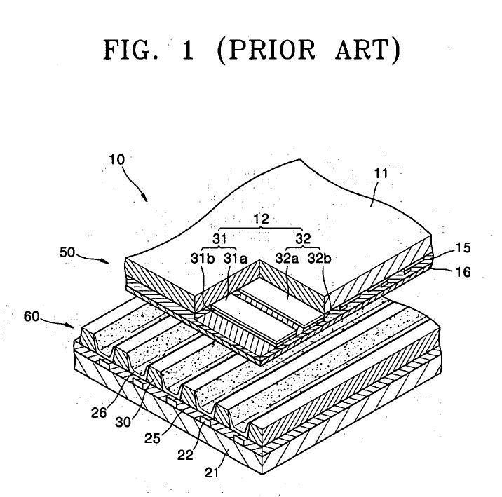

FIG. 2 is a cross-sectional view illustrating an example of distribution of wall charges and discharge path in the plasma display panel of FIG. 1, where a lower plate thereof is rotated at about 90°.

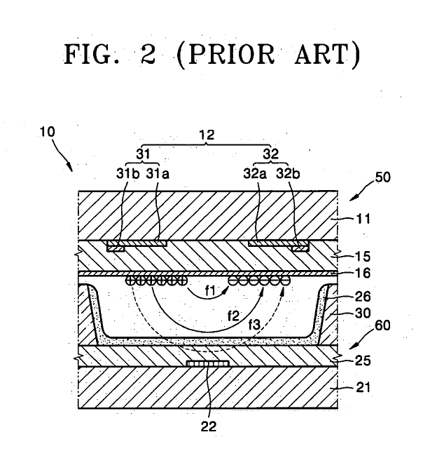

FIG. 3 is an exploded perspective view of the plasma display panel according to an embodiment of the present invention.

FIG. 4 is a cross-sectional view illustrating the plasma display panel of FIG. 3, where the lower plate thereof is rotated at about 90°.

FIG. 5 is a perspective view of the modified upper plate of the plasma display panel of FIG. 3.

FIG. 6 is a cross-sectional view illustrating an example of distribution of wall charges and discharge path in the plasma display panel of FIG. 3, where the lower plate thereof is rotated to about 90°.

### DETAILED DESCRIPTION OF THE INVENTION

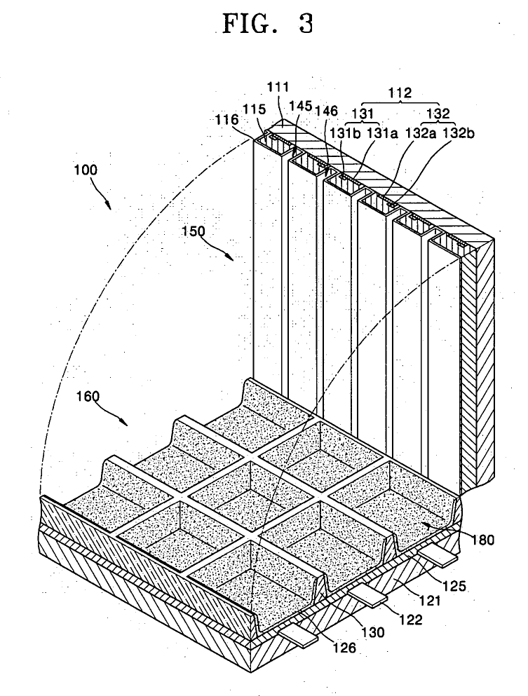

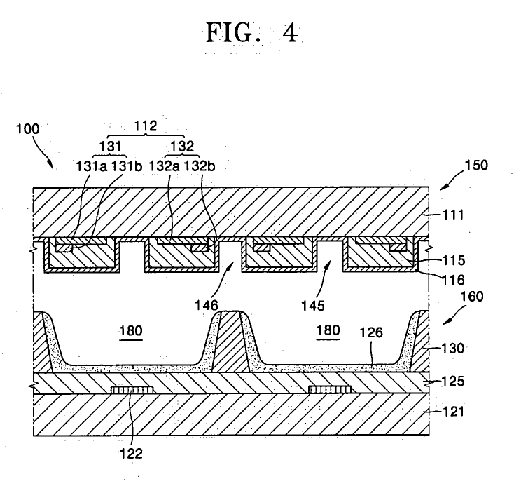

Referring now to FIGS. 3 and 4, a plasma display panel 100 according to a desirable embodiment of the present invention is shown. In FIG. 4 the lower plate 160 of FIG. 3 is shown rotated at an angle of about 90°, for the convenience of explanation.

Referring to FIG. 3, the plasma display panel 100 includes an upper plate 150 and a lower plate 160. To show the features of lower plate 160, the upper plate 150 has been drawn in an upright position. However in use, the top plate 150 would be coupled to be parallel the lower plate 160.

The lower plate 160 may include a back substrate 121, and the upper plate 150 may include a front substrate 111 aligned with and arranged opposite the back substrate 121. One or more intersecting partition walls 130 may be disposed between the front substrate 111 and the back substrate 121 to partition the lower plate 160 into a plurality of discharge cells 180. An address electrode 122 may extend across each row of discharge cells 180. A first dielectric layer 125 may cover each of the address electrodes 122. One or more fluorescent layers 126 may be arranged inside each of the discharge cells 180. Adjacent pairs of sustain electrodes 112 may extend across a back surface of the front substrate 111 in a direction that intersects the direction of the address electrodes 122. A second dielectric layer 115 may be used to cover the pairs of the sustain electrodes 112 and may also be colored. Finally, a discharge gas may be injected and sealed inside each of the discharge cells 180.

The pairs of the sustain electrodes 112 are arranged in the front substrate 111 of the upper plate 150. In the present embodiment, because visible rays generated inside the discharge cells 180 are emitted outside through the front substrate 111, the front substrate 111 is preferably made of transparent materials such as glass.

Each pair of sustain electrodes 112 may include a pair of X electrodes 131 and Y electrodes 132 formed at a back surface of the front substrate 111 to generate a sustain discharge. The pairs of sustain electrodes 112 may be arranged to be parallel at a predetermined distance from each other on the back surface of the front substrate 111.

Each of the X electrodes 131 and the Y electrodes 132 is provided with transparent electrodes 131a, 132a and bus electrodes 131b, 132b. The transparent electrodes 131a, 132a are formed of transparent materials which are electric conductors capable of generating discharge and do not prevent visible rays emitting from fluorescent layers 126 from going toward the front substrate 111. These materials are ITO (indium tin oxide), etc. However, a transparent electric conductor such as the ITO generally has a large resistance. Therefore, if sustain electrodes are made of only transparent electrodes, there is a large voltage drop in a longitudinal direction, requiring a lot of drive power and delaying response speed. In order to overcome these problems, narrow bus electrodes 131b, 132b made of metal materials are arranged at outside ends of the transparent electrodes.

The address electrodes 122 intersecting the X electrodes 131 and the Y electrodes 132 of the front substrate 111 are arranged on the back substrate 121 opposite to surfaces where pairs of sustain electrodes 112 are arranged.

The address electrodes 122 functions as generating address discharge to allow the sustain discharge between the X electrodes 131 and the Y electrodes 132 to occur more easily, and specifically, as lowering a voltage to generate the sustain discharge. The address discharge occurs between the Y electrodes 132 and the address electrodes 122. When the address discharge is ended, cat-ions are stored at the Y electrodes 132 side and electrons are stored at the X electrodes 131 side, whereby the sustain discharge between the X electrodes 131 and the Y electrodes 132 occur more easily.

Space formed by a pair of the X electrodes 131 and the Y electrodes 132 and the corresponding intersecting address electrodes 122 forms a unit discharge cell 180.

A first dielectric layer 125 is formed to bury the address electrodes 122 on the back substrate 121. The first dielectric layer 125 prevents charged particles or electrons from colliding with the address electrodes 122 and causing damage to them during discharging, and inducing the wall charges. The first dielectric layer 125 may be made of a dielectric substance such as PbO, B₂O₃, SiO₂, etc.

The second dielectric layer 115 is formed to bury pairs of the sustain electrodes 112 on the front substrate 111. The second dielectric layer 115 prevents adjacent X electrodes 131 and Y electrodes 132 from being connected electrically during main discharging and also prevents charged particles or electrons from colliding with the sustain electrodes 131, 132 and causing damaged to them, and storing wall charges induced by the charged particles.

In the plasma display panel 100 according to an embodiment of the present invention, the second dielectric layer 115 may be colored to increase contrast when viewed in the ambient light of a room. Because absorption of visible rays incident from outside by the colored second dielectric layer 115 reduces the reflected luminance of external light and increases the contrast in the light room. At this time, it is preferable that the second dielectric layer 115 has light transmittance of about 50% to about 80% for visible rays. Such a colored second dielectric layer 115 may be formed by adding dark color pigments to a transparent dielectric substance such as PbO, B₂O₃, SiO₂, etc.

Grooves 145 having a predetermined depth may be formed in the second dielectric layer 115 between the X electrodes 131 and the Y electrodes 132 forming the pairs 112. The grooves 145 allow thinner second colored dielectric layers 115. This decreases the amount of visible rays generated in the discharge cells 180 and absorbed in the second dielectric layer. Specifically, in order to maximize the brightness in the plasma display panel 100, as shown in FIG. 3 and FIG. 4, it is preferable that the grooves 145 are formed to penetrate the second dielectric layer 115.

In the plasma display panel 100 according to an embodiment of the present invention, the grooves 145 may be formed to be consecutively extended between the X electrodes 131 and the Y electrodes 132. In such a configuration, the grooves 145 may also be used as exhaust passages for the discharge gas.

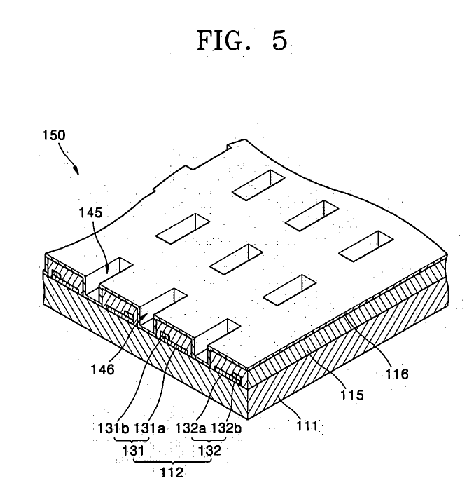

However, as shown in FIG. 5, the grooves 145 formed in the second dielectric layer 115 may be discontinuously formed, one per unit discharge cell 180. In other words, the grooves 145 need not extend over two or more adjacent unit discharge cells 180. It will be appreciated that the perimeter shapes of the grooves 145 are not limited to the shapes shown, but may include other shapes and/or patterns.

Further, the grooves 146 may be further formed in a non-discharge area of the second dielectric layer 115 between the X electrodes 131 and the Y electrodes 132 forming the pairs 112. In FIGS. 3 and 4, as an example of these non-discharge areas, the grooves 146 are formed between adjacent pairs of sustain electrodes 112. Whereas grooves 145 may be formed near the center of a unit discharge cell 180, the grooves 146 may be formed above the partition walls 130. The grooves 146 may be formed to be extended in the same direction as the sustain electrodes 131, 132 are extended. Specifically, the grooves 146 may be formed to correspond to the partition walls 130, which are arranged in a direction that corresponds to the orientation of the sustain electrodes 131, 132. The shape and number of the grooves 146 formed in the non-discharge area are not limited to the shape and number of the grooves mentioned above.

In a PDP manufactured according to the principles of the present invention, the display brightness is maximized because the percentage of visible rays generated in the discharge cells 180 that are absorbed in the second dielectric layer 115 is decreased by the grooves 145 and 146, which are formed in the second dielectric layer 115. To maximize the screen brightness of the plasma display panel 100, shown in FIGS. 3 and 4, the grooves 145, 146 may be formed to penetrate the second dielectric layer 115. Further, the geometric configuration and number of the grooves 145 and 146 arranged in each discharge cells 180 may be selected differently from each other, but it is preferable that the grooves 145 and 146 arranged in each discharge cells 180 are configured to be symmetrical.

Referring again to FIG. 5, one or more protective layers 116 made of MgO or similar material may be formed on the second dielectric layer 115. Protective layers 116 prevent charged particles and electrons from colliding with the second dielectric layer 115 and causing damage to them during discharging. Additionally, the protective layers 116 have good light transmittance and emit many secondary electrons during the discharging process.

The partition walls 130, which preserve an optimum discharge distance and prevent electrical and optical cross-talk between the discharge cells 180, may be formed between the first dielectric layer 125 and the second dielectric layer 115.

In FIG. 3, the partition walls 130 are shown in a matrix shape (i.e., as an orthogonal grid), but the geometric pattern created by the partition walls is not limited to the shape illustrated. As long as the partition walls 130 can form a plurality of discharge cells, they can be divided in various patterns. Examples include: open shapes such as stripes, etc. as well as closed shapes such as waffle, matrix, delta, and other patterns. Further, the geometrical cross-section of the discharge cells and their corresponding partition walls in a closed shape can be formed to be polygonal, and may include such cross-sectional shapes as a triangle, pentagon, etc. Alternatively, the cross-sectional shape may include curved shapes such as circles, ovals, etc. in addition to the rectangles illustrated in the Figures as describing one embodiment of the invention.

The fluorescent layers 126 for emitting red, green, and blue light may be arranged on both sides of these partition walls 130 and on the front surface of the first dielectric layer 125 in which the partition walls 130 are not formed.

The fluorescent layers 216 may include a component which receives ultraviolet rays and emits visible rays. The fluorescent layers that are formed in sub-pixels for emitting red light may include a fluorescent substance such as Y(V, P)O₄:Eu, etc. The fluorescent layers formed in sub-pixels for emitting green light may include a fluorescent substance such as Zn₂SiO₄:Mn, YBO₃:Tb, etc. The fluorescent layers formed in sub-pixels for emitting blue light may include a fluorescent substance such as BAM:Eu, etc.

Discharge gas such as Ne, Xe, etc., and a mixture thereof may be injected and sealed inside the discharge cells 180.

In use, a plasma panel 100 manufactured according to the principles of the present invention having the above-described structure may function as follows.

Application of an address voltage between the address electrodes 122 and the Y electrodes 132 generates an address discharge. This address discharge determines and selects the discharge cells 180 in which the sustain discharge is to occur.

Thereafter, when a discharge sustain voltage is applied between the X electrodes 131 and the Y electrodes 132 of the selected discharge cells 180, cat-ions stored on the Y electrodes 132 and electrons stored on the X electrodes 131 collide to generate a sustain discharge. During the sustain discharge, ultraviolet rays are emitted as the energy level of excited discharge gas lowers. The emitted ultraviolet rays excite the fluorescent layers 126 coated inside the discharge cells 180 and visible light rays are emitted as the energy level of the excited fluorescent layers 126 lowers. When viewed, the emitted visible rays display an image.

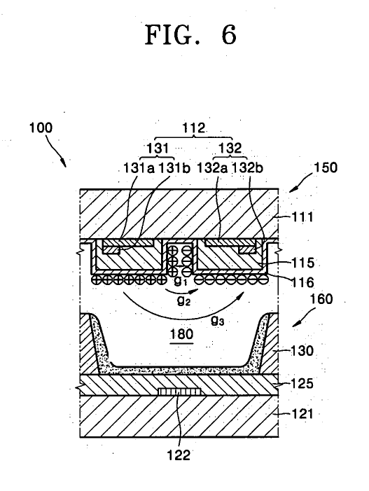

FIG. 6 shows a distribution of wall charges and their respective discharge paths at one section of a sustain discharge unit in the plasma display panel 100, according to an embodiment of the present invention.

Because the sustain discharge starts between the X electrodes 131 and the Y electrodes 132, the plasma density converges on portions between the electrodes 131 and 132. Because of high density of electrons and ions, the plasma discharge then spreads to the central portions of the electrodes 131 and 132, and then spreads outside the electrodes 131 and 132.

For ease of explanation and illustration, the overall discharge path may be divided into a first path g1 in which the discharge occurs between the electrodes 131 and 132; a second path g2 in which the discharge occurs from central portions of the electrodes 131 and 132; and a third path g3 in which the discharge occur outside the electrodes 131 and 132. As described above, the discharge is substantially spread sequentially from the first path g1, the second path g2, and the third path g3.

When discharge occurs via the first path g1 and the second path g2, across the grooves 145 formed in the second dielectric layer 125, the electric field converges, reducing the length of the discharge path, and increasing the discharge area. Consequently, it may decrease a firing discharge voltage and a sustain discharge voltage for sustain discharge.

Further, unlike that of the conventional plasma display panel 10, a sustain discharge vigorously occurs in the third path g3 as well as the first path g1 and the second path g2. The reason is that sufficient wall electric charges exist outside the electrodes 131,132 by virtue of the grooves 145. Additionally, in the configuration shown, the presence of adjacent partition walls 130 will not appreciably prevent discharge as is the case in the plasma display panel 10. This benefit occurs, in part, because a discharge path is secured outside the electrodes 131 and 132, which generates more charged particles, excited particles, etc. than conventional configurations. Therefore, a firing discharge voltage and a sustain discharge voltage decrease while luminous efficiency increases.

The grooves 145 and 146 may be formed in the second dielectric layer 115 using any of various methods or combinations thereof. For example, grooves 145 and 146 may be formed by sandblasting, screen printing, dry film, etching, etc.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display panel, comprising:
a back substrate;
a front substrate opposite the back substrate;
partition walls disposed between the front substrate and the back substrate to partition a plurality of discharge cells;
an address electrode extending across at least two adjacent discharge cells of the plurality of discharge cells;
a first dielectric layer covering the address electrode;
a pair of sustain electrodes extending in a direction to intersect the address electrode;
a second dielectric layer that covers the pair of the sustain electrodes and is colored;
one or more fluorescent layers arranged inside each of the plurality of discharge cells; and
discharge gas injected inside each of the discharge cells,
wherein a groove is formed on the second dielectric layer and between the pair of sustain electrodes.

2. The plasma display panel of claim 1, wherein the second dielectric layer has a light transmittance rate of about 50% to about 80%.

3. The plasma display panel of claim 1, wherein the second dielectric layer comprises transparent dielectric material and a dark color pigment.

4. The plasma display panel of claim 1, wherein each of the groove penetrates the second dielectric layer.

5. The plasma display panel of claim 1, wherein a protective layer is formed on the second dielectric layer where the groove is formed.

6. The plasma display panel of claim 1, wherein the groove is further formed in a non-discharge area of the second dielectric layer.

7. The plasma display panel of claim 6, wherein the groove is formed between the adjacent pairs of sustain electrodes.

8. The plasma display panel of claim 6, wherein the groove is symmetrical.

9. The plasma display panel of claim 6, wherein the groove penetrates the second dielectric layer.

10. The plasma display panel of claim 1, wherein the groove is formed in a direction where the sustain electrodes extend.

11. A plasma display panel, comprising:
a back substrate;
a front substrate facing the back substrate;
partition walls disposed between the front substrate and the back substrate to partition a plurality of discharge cells;
an address electrode extending across the at least two adjacent discharge cells of the plurality of discharge cells;
a first dielectric layer covering the address electrode;
a pair of sustain electrodes extending in a direction to intersect the address electrode;
a second dielectric layer that individually covers the sustain electrodes and is colored;
a fluorescent layer arranged inside each of the plurality of discharge cells; and
discharge gas present within each of the plurality of discharge cells.

12. The plasma display panel of claim 11, wherein the second dielectric layer have a light transmittance of about 50% to about 80%.

13. The plasma display panel of claim 11, wherein the second dielectric layer comprises a transparent dielectric substance and a dark color pigment.

14. The plasma display panel of claim 11, wherein the protective layer is formed in the second dielectric layer.
